(19) United States
(12) Patent Application Publication
(10) Pub. No.: US 2002/0019752 A1
(43) Pub. Date: Feb. 14, 2002

(54) System for therapy management and terminal used therefor

(76) Inventor: Isamu Takase, Tokyo (JP)

Correspondence Address: BIRCH STEWART KOLASCH & BIRCH, PO BOX 747, FALLS CHURCH, VA, 22040-0747, US

(21) Appl. No.: 09/886,380

(22) Filed: Jun. 22, 2001

(30) Foreign Application Priority Data
Jun. 23, 2000 (JP) 2000-229983
Dec. 7, 2000 (JP) 2000-373436

(51) Int. Cl. G06F 17/60

(52) U.S. Cl. 705/3

(57) ABSTRACT

Providing an accurate and effective exchange of information between the physician and the patient regarding the disease condition and the physician's instruction. A therapy management system includes a host computer on the side of a physician and a patient's computer. The host computer provides a recording device to record a physician's instruction and a memory device etc., and the patient's computer includes a receiving device to receive the physician's instruction, a display device, a notifying device, recording device and a memory device etc.

### BACKGROUND OF THE INVENTION

1. Field of the Invention

The present invention relates to a therapy management system based on the use of a computer on the side of a patient whereby it is possible for a physician to examine the patient, prescribe a therapy and educate the patient, and for the patient to receive the prescription, do as instructed by the physician, and report the result to the physician.

The present invention particularly relates to a system for managing therapy based on the use of a portable terminal carried by a patient.

The present invention also relates to a host computer and a patient side computer, a portable terminal, a portable telephone unit carried by a patient.

2. Description of the Related Art

Today, in not only Japan but also various countries with the increase of elderly people in the population, and of the incidence of diseases based on everyday habits, an increasingly large number of people suffer from diseases requiring protracted therapy. To meet this situation, physicians must examine such patients for long periods, and prescribe them medicine and educate them healthy ways of living.

In other respects, it becomes a custom for physicians to feed data obtained by examining patients, histories of medication, and courses of treatment into a computer for the management of those data.

In still other respects, it has been proposed the patient, by utilizing appropriate machines, should manage or check his/her health state at home, or more particularly, adjust his/her daily dose of a medicine, the content and calorie of a meal, and the amount of exercise by making a necessary calculation by him/herself.

Under this situation, the information quantities separately possessed by the physician and the patient tend to increase. However, exchange of the information between the physician and the patient is still insufficient: transmission of the information from the physician to the patient regarding the prescription or instructions, for example, usually occurs by mouth or through a simple memo, when the physician examines the patient at his office.

Now, turn our attention to diabetes. As far as based on reported results, in Japan currently there are seven millions people who suffer from diabetes, and it is said that the patients in whom diabetes does exist but is still latent are three times as many as the patients reported to be diabetic. The danger of this disease lies in followings: the patient does not have a subjective feeling of contracting a disease; the patient must control the disease throughout the rest of his/her life after he/she contracted the disease; and thus the therapy requires from the patient an endurance sufficiently strong to faithfully stick to the prescription given to him/her.

### SUMMARY OF THE INVENTION

This invention aims at facilitating an accurate and effective exchange of information between the physician and the patient, that is, transmission of the information regarding the prescription and instructions from the physician to the patient, and transmission of the information regarding the disease condition from the patient to the physician, through the intervention of a computer, particularly a terminal, or more preferably a portable terminal.

Through this arrangement, it will be possible for the physician to accurately grasp the disease condition of the patient, and for the patient to rightly understand the prescription and instructions given to him/her, which will help the patient accurately and easily observe the prescription and instructions.

This invention relates to a therapy management system based on the use of a computer, particularly a portable terminal or a portable telephone unit wherein the patient has a computer, or more preferably a portable terminal connected through a network to a computer, a host computer on the side of the physician; the patient receives the prescription and instructions from the physician through the computer or the portable terminal; and the patient acts as prescribed and instructed, and reports the course of actions and their result to the physician using the computer, particularly the portable terminal or portable telephone unit.

### BRIEF DESCRIPTION OF THE DRAWINGS

FIG. 1 is a display for the information of therapy and instructions.

FIG. 2 is a menu display for diabetic therapy.

FIG. 3 is a menu display for therapy and instructions.

FIG. 4 is a menu display for therapy and instructions.

FIG. 5 is a menu display through which one can set the program of a selected day.

FIG. 6 is a menu display through which one can set a time for a daily habit.

FIG. 7 is a menu display through which one can set diet units for a meal.

FIG. 8 is a menu display through which one can set diet units for a meal.

FIG. 9 is a menu display through which one can change the schedule of a selected day.

FIG. 10 is a display prompting one to change the time of a meal.

FIG. 11 is a menu display through which one can set a time for a meal.

FIG. 12 is a display presenting the schedule of a selected day.

FIG. 13 is a display prompting one to measure the blood sugar.

FIG. 14 is a menu display through which one can enter a numerical value representing a blood sugar measurement.

FIG. 15 is a display prompting one to inject insulin.

FIG. 16 is a display presenting the schedule of a selected day.

FIG. 17 is a display through which one can enter the amount of exercise and others (therapy-related instructions).

FIG. 18 is a display through which one can enter a numerical value representing the amount of exercise.

FIG. 19 is a menu display through which one can enter special notes.

FIG. 20 is a menu display for diet management.

FIG. 21 is a menu display of dishes.

FIG. 22 is a menu display of dishes.

FIG. 23 is a menu display for diet management.

FIG. 24 is a menu display of dishes.

FIG. 25 is a menu display of dishes.

FIG. 26 is a display for diet management.

FIG. 27 is a display for therapy and instructions (pull-down menu for viewing other data).

FIG. 28 is a menu display through which one can set a time for a daily habit.

FIG. 29 is a display presenting the program of a selected day.

FIG. 30 is a display presenting the change of blood sugar level.

FIG. 31 is a display presenting the change of exercise amount.

FIG. 32 is a display presenting the changes of body weight and fat.

FIG. 33 is a display presenting the change of blood pressure.

FIG. 34 is a menu display through which one can enter special notes.

### DETAILED DESCRIPTION OF THE INVENTION

The present invention will be described in detail in the following.

The physician examines the patient; notes the therapy necessary for the patient, names of medicines and their dosage, contents of diet and their calories, exercise required for the recovery of physical strength, management schedule, rules to be observed in everyday life, and necessary test items and the methods used for their practice; feeds those data regarding the therapy and instructions into a host computer for storage; and then transmits the information carrying the therapy and instructions to a computer or more preferably a portable terminal or a portable telephone unit on the side of the patient.

The patient views the information carrying the therapy and instructions on the computer, or more preferably on the portable terminal or on the portable telephone unit which has received the information; cares his/her body, ingests proper medicines, takes proper diet, practices proper exercise, and receives proper tests, as prescribed and instructed; and registers the information regarding the disease course and therapy result to the computer, or to the portable terminal or to the portable telephone unit.

The patient connects the computer, portable terminal or portable telephone unit storing the information of the disease course and therapy result, to the network for transmitting the information to the host computer on the side of the physician; or when the patient revisits, for examination, the hospital where the physician resides, he/she carries the portable terminal or the portable telephone unit, and transmits the information of the disease course and therapy result to the host computer on the side of the physician.

The physician grasps the current disease condition of the patient by referring to the data stored in the host computer, as well as to the data regarding the patient's condition at home. Being based on such knowledge, the physician can give a proper prescription and advice to the patient, and use the data as a reference material which will be required when the physician examines the patient at a next interview.

The present invention will be described in detail in the following.

The physician examines the patient; notes the therapy necessary for the patient, names of medicines and their dosage, contents of diet and their calories, exercise required for the recovery of physical strength, management schedule, rules to be observed in everyday life, and necessary test items and the methods used for their practice; feeds those data regarding the therapy and instructions into a host computer for storage; and then transmits the information carrying the therapy and instructions to a computer or more preferably a portable terminal or a portable telephone unit on the side of the patient.

The patient views the information carrying the therapy and instructions on the computer, or more preferably on the portable terminal or on the portable telephone unit which has received the information; cares his/her body, ingests proper medicines, takes proper diet, practices proper exercise, and receives proper tests, as prescribed and taught; and registers the information regarding the disease course and therapy result to the computer, or to the portable terminal.

The patient connects the computer, portable terminal or portable telephone unit storing the information of the disease course and therapy result, to the network for transmitting the information to the host computer on the side of the physician; or when the patient visits, for examination, the hospital where the physician resides, he/she preferably carries the portable terminal or the portable telephone unit, and transmits the information of the disease course and therapy result to the host computer on the side of the physician.

The physician-grasps the current disease condition of the patient by referring to the data stored in the host computer, as well as to the data regarding the patient's condition at home. Being based on such knowledge, the physician can give a proper prescription and advice to the patient, and use the data as a reference material which will be required when the physician examines the patient at a next visit.

The physician feeds the data regarding the condition of the patient into the host computer, while the patient transmits the data regarding the condition and therapy result fed into his/her computer, portable terminal or portable telephone unit to the host computer on the side of the physician. In this system, the host computer on the side of the physician serves as a server of a network through which, not to mention a plurality of physicians including the physician here concerned can gain access to the host computer, but their patients can gain access to the host computer from a proper site abroad as well as domestic to transmit necessary data to it, using a proper means or device.

An object of this invention is to provide a therapy management system having a host computer on the side of a physician and a computer on the side of a patient wherein the physician side host computer comprises at least:

a display means to display the information of therapy instructions including the name of the patient, the treatment data of the patient, and the instructions from the physician;

a recording means to record the name of the patient, the treatment data of the patient, and the instructions from the physician;

a memory means to store the name of the patient, the treatment data of the patient, and the instructions from the physician;

a transmission means to transmit the information of therapy instructions to the patient side computer;

a receiving means to receive the information of patient's report result transmitted by the patient side computer;

a display means to display the information of patient's report result;

a memory means to store the information of patient's report result;

a memory means to store the information of the patient's past medical history;

a memory means to store the information of patient's past report result;

a memory means to store the information of updated therapy instructions; and

a transmission means to transmit the information of updated therapy instructions to the patient side computer,

while the patient side computer comprises at least:

a receiving means to receive the information of therapy instructions including the name of the patient, the treatment data of the patient, and the instructions from the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a recording means to record the treatment data obtained by measurement;

a display means to display the treatment data obtained by measurement;

a memory means to store the treatment data obtained by measurement; and

a transmission means to transmit the stored information of the patient's report result to the host computer on the side of the physician.

Another object of this invention is to provide a therapy management system having a host computer on the side of a physician and a portable terminal on the side of a patient wherein the physician side host computer comprises at least:

a display means to display the information of therapy instructions including the name of the patient, the treatment data of the patient, and the instructions from the physician;

a recording means to record the name of the patient, the treatment data of the patient, and the instructions from the physician;

a memory means to store the name of the patient, the treatment data of the patient, and the instructions from the physician;

a transmission means to transmit the information of therapy instructions to the patient side computer;

a receiving means to receive the information of patient's report result transmitted by the patient side computer;

a display means to display the information of patient's report result;

a memory means to store the information of patient's report result;

a memory means to store the information of the patient's past medical history;

a memory means to store the information of patient's past report result;

a memory means to store the information of updated therapy instructions; and

a transmission means to transmit the information of updated therapy instructions to the patient side computer,

while the patient side portable terminal comprises at least:

a receiving means to receive the information of therapy instructions including the name of the patient, the treatment data of the patient, and the instructions from the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a recording means to record the treatment data obtained by measurement;

a display means to display the treatment data obtained by measurement;

a memory means to store the treatment data obtained by measurement; and

a transmission means to transmit the stored information of the patient's report result to the host computer on the side of the physician.

A further object hereof is to provide a therapy management system having a host computer on the side of a physician and a portable telephone unit on the side of a patient wherein the physician side host computer comprises at least:

a display means to display the information of therapy instructions including the name of the patient, the treatment data of the patient, and the instructions from the physician;

a recording means to record the name of the patient, the treatment data of the patient, and the instructions from the physician;

a memory means to store the name of the patient, the treatment data of the patient, and the instructions from the physician;

a transmission means to transmit the information of therapy instructions to the patient side computer;

a receiving means to receive the information of patient's report result transmitted by the patient side computer;

a display means to display the information of patient's report result;

a memory means to store the information of patient's report result;

a memory means to store the information of the patient's past medical history;

a memory means to store the information of patient's past report result;

a memory means to store the information of updated therapy instructions; and

a transmission means to transmit the information of updated therapy instructions to the patient side computer,

while the patient side portable telephone comprises at least:

a receiving means to receive the information of therapy instructions including the name of the patient, the treatment data of the patient, and the instructions from the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a recording means to record the treatment data obtained by measurement;

a display means to display the treatment data obtained by measurement;

a memory means to store the treatment data obtained by measurement; and

a transmission means to transmit the stored information of the patient's report result to the host computer on the side of the physician.

A further object hereof is to provide a therapy management system having the physician side host computer comprises at least:

a display means to display the information of therapy instructions including the name of the patient, the treatment data of the patient, and the instructions from the physician;

a recording means to record the information of therapy instructions including the name of the patient, the treatment data of the patient, and the instructions from the physician;

a memory means to store the information of therapy instructions including the name of the patient, the treatment data of the patient, and the instructions from the physician;

a transmission means to transmit the information of therapy instructions to the patient side computer;

a receiving means to receive the information of patient's report result transmitted from the patient side;

a display means to display the information of patient's report result;

a memory means to store the information of patient's report result;

a memory means to store the information of the patient's past medical history;

a memory means to store the information of patient's past report result;

a memory means to store the information of updated therapy instructions; and

a transmission means to transmit the information of updated therapy instructions to the patient side computer,

while the patient side computer comprises at least:

a receiving means to receive the information of therapy instructions including the name of the patient, the treatment data of the patient, and the instructions from the physician transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display an exercise amount;

a recording means to record an amount of exercise actually performed;

a memory means to store the record; and

a transmission means to transmit the stored information of the patient's report result to the host computer on the side of the physician.

Another object of this invention is to provide a therapy management having the portable terminal on the side of the patient comprises at least:

a receiving means to receive the information of therapy instructions including the name of the patient, the treatment data of the patient, and the instructions from the physician, transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display an exercise amount;

a recording means to record an amount of exercise actually performed;

a memory means to store the record; and

a transmission means to transmit the stored information of the patient's report result to the host computer on the side of the physician.

The present invention also provides a therapy management system having the portable terminal on the side of the patient comprises at least:

a receiving means to receive the information of therapy instructions including the name of the patient, the treatment data of the patient, and the instructions from the physician, transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display the time for dispensing a medicine;

a memory means to store a time for dispensing a medicine;

a notifying means to notify the time for dispensing a medicine;

a recording means to record the result of the dispensation of a medicine;

a display means to display the result of the dispensation of a medicine;

a memory means to store the result of the dispensation of a medicine;

a display means to display a time of insulin injection;

a memory means to store the time for insulin injection;

a notifying means to notify the time for insulin injection;

a recording means to record the result of insulin injection;

a display means to display the result of insulin injection;

a memory means to store the result of insulin injection;

a display means to display an exercise amount;

a recording means to record an amount of exercise actually performed;

a memory means to store the record; and

a transmission means to transmit the stored information of the patient's report result to the host computer on the side of the physician.

A further object hereof is to provide a patient side computer used for the therapy management system as described above to be applied to a diabetic patient and a patient side computer comprising at least:

a receiving means to receive the information of therapy instructions including the name of the patient, the treatment data of the patient, and the instructions from the physician, transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display a time for dispensing a medicine;

a memory means to store the time for dispensing a medicine;

a notifying means to notify the time for dispensing a medicine;

a recording means to record the result of the dispensation of a medicine;

a display means to display the result of the dispensation of a medicine;

a memory means to store the result of the dispensation of a medicine;

a display means to display a time of insulin injection;

a memory means to store the time for insulin injection;

a notifying means to notify the time for insulin injection;

a recording means to record the result of insulin injection;

a display means to display the result of insulin injection;

a memory means to store the result of insulin injection;

a display means to display an exercise amount;

a recording means to record an amount of exercise actually performed;

a memory means to store the record; and

a transmission means to transmit the stored information of the patient's report result to the host computer on the side of the physician.

A further object hereof is to provide a portable terminal for a diabetic patient comprising at least:

a receiving means to receive the information of therapy instructions including the name of the patient, the treatment data of the patient, and the instructions from the physician, transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display a time for dispensing a medicine;

a memory means to store the time for dispensing a medicine;

a notifying means to notify the time for dispensing a medicine;

a recording means to record the result of the dispensation of a medicine;

a display means to display the result of the dispensation of a medicine;

a memory means to store the result of the dispensation of a medicine;

a display means to display a time for insulin injection;

a memory means to store the time for insulin injection;

a notifying means to notify the time for insulin injection;

a recording means to record the result of insulin injection;

a display means to display the result of insulin injection;

a memory means to store the result of insulin injection;

a display means to display an exercise amount;

a recording means to record an amount of exercise actually performed;

a memory means to store the record; and

a transmission means to transmit the stored information of the patient's report result to the host computer on the side of the physician.

A further object hereof is provide a portable telephone unit for a diabetic patient comprising at least:

a receiving means to receive the information of therapy instructions including the name of the patient, the treatment data of the patient, and the instructions from the physician, transmitted from the host computer on the side of the physician;

a memory means to store the thus received information of therapy instructions including the name of the patient, the treatment data of the patient, and the instructions from the physician;

a display means to display the thus received information of therapy instructions including the name of the patient, the treatment data of the patient, and the instructions from the physician;

a display means to display the actions to be taken by the patient in compliance with the instructions from the physician;

a notifying means to notify the patient of the actions to be taken in compliance with the instructions from the physician;

a recording means to record the actions actually taken by the patient in compliance with the instructions from the physician;

a memory means to store the recorded content;

a display means to display the time of meal;

a setting means through which one can set the time of meal;

a memory means to store the time of meal thus set;

a notifying means to notify the time of meal thus set;

an altering means through which one can alter the set time of meal;

a display means to display the time of meal thus altered;

a memory means to store the time of meal thus altered;

a display means to display the diet unit of a meal;

a setting means through which one can set the diet unit of a meal;

a memory means to store the diet unit of a meal thus set;

a display means to display a time for blood sugar measurement;

a memory means to store the time for blood sugar measurement;

a notifying means to notify the time for blood sugar measurement;

a recording means to record a blood sugar level obtained by measurement;

a display means to display the blood sugar level thus recorded;

a memory means to store the blood sugar level thus recorded;

a display means to display a time for dispensing a medicine;

a memory means to store the time for dispensing a medicine;

a notifying means to notify the time for dispensing a medicine;

a recording means to record the result of the dispensation of a medicine;

a display means to display the result of the dispensation of a medicine;

a memory means to store the result of the dispensation of a medicine;

a display means to display a time for insulin injection;

a memory means to store the time for insulin injection;

a notifying means to notify the time for insulin injection;

a recording means to record the result of insulin injection;

a display means to display the result of insulin injection;

a memory means to store the result of insulin injection;

a display means to display an exercise amount;

a recording means to record an amount of exercise actually performed;

a memory means to store the record; and

a transmission means to transmit the stored information of the patient's report result to the host computer on the side of the physician.

Other objects and advantages will become apparent as this disclosure proceeds.

This invention will be described in detail below taking, for illustration, a case where this invention is applied for the treatment of a diabetic patient through the use of a computer or preferably a portable terminal.

Firstly, the physician in charge implements the initial setting of a therapy-oriented portable terminal to be handed to the patient which will serve as a computer on the side of the patient. The physician implements the initial setting by firstly feeding an ID and password, so that the data subsequently fed may not be altered by the patient. The ID and password are chosen by the physician as appropriate.

The physician examines the patient; determines a necessary therapy to meet the disease; prepares the information carrying the prescription and instructions directed to the patient; and feeds the information into a host computer on his/her side for storage.

The information includes followings for this particular case: date of the initial setting, name of the hospital, name of the physician, name of the patient, medical record No., type of insulin prescribed, the method and number of insulin administration, dosage of insulin, HbAlc (hemoglobin Alc) measurements (HbAlc measurement indicates the daily average of blood sugar level over the last two months) (the blood sugar levels determined by the physician and the patient, and the HbAlc measurement serve as a reference by which one can determine how well the disease is controlled), date of HbAlc measurements, prescribed daily diet units of each meal and actually consumed diet units of each meal, targeted amount of exercise (expressed in terms of steps measured with a pedometer for walking), etc.

Then, the physician transmits the information carrying the prescription and instructions through the host computer to the portable terminal carried by the patient. In this operation, the physician separates the data necessary for the patient from unnecessary data, and transmits only the former to the patient.

When the patient revisits the hospital, and the physician examines the patient, the physician updates the information of the prescription and instructions, based on the findings obtained in this examination. In this operation, the history of alterations applied to the prescription is registered in the host computer.

The patient or patient A looks at the screen of his/her portable terminal (FIG. 1), notes the prescription and instructions displayed there, engages in the control of diabetes following the prescription and instructions, and feeds daily data required for the control of diabetes by hand or with an automated means.

The operation of the therapy-oriented portable terminal by patient A will proceed as follows.

The operation of the portable terminal by patient A may roughly consist of following four categories.

1) Implementing initial settings for him/herself.

2) Feeding diabetic control actions actually performed in accordance with the prescription and instructions displayed on the portable terminal.

3) Feeding various data required for the control of the diabetes.

4) Reviewing the various data fed during the control of the diabetes.

The steps actually employed under the respective categories will be described in the order of categories.

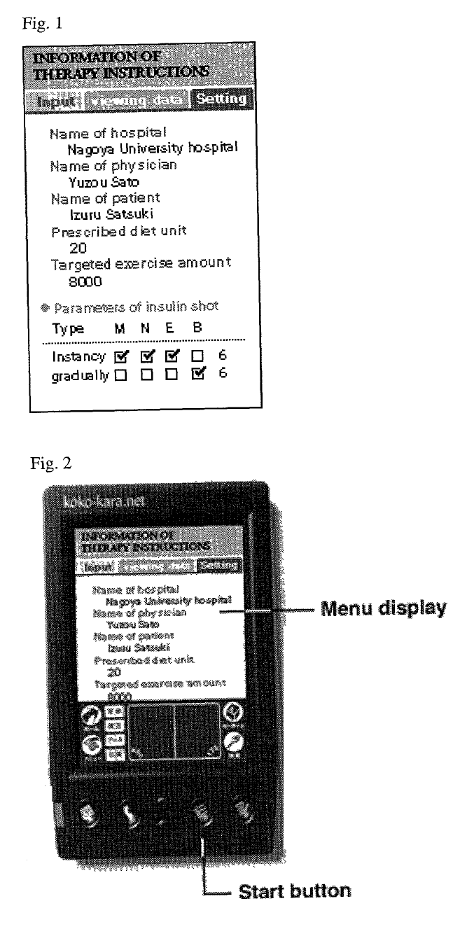

If patient A presses a start button as shown in FIG. 2 of the therapy-oriented portable terminal, the terminal will be automatically turned on, and give a display (menu display hereinafter) as shown in FIG. 2 carrying a menu for the control of diabetes.

The initial setting performed by the patient includes followings.

The initial setting performed by the patient relates to everyday rules specific to the patient which are important for the patient to effectively control the diabetes at home. If set properly, the portable terminal will help the patient effectively take various actions necessary for the successful control of the diabetes.

The display menus through which one can implement or alter settings are as follows.

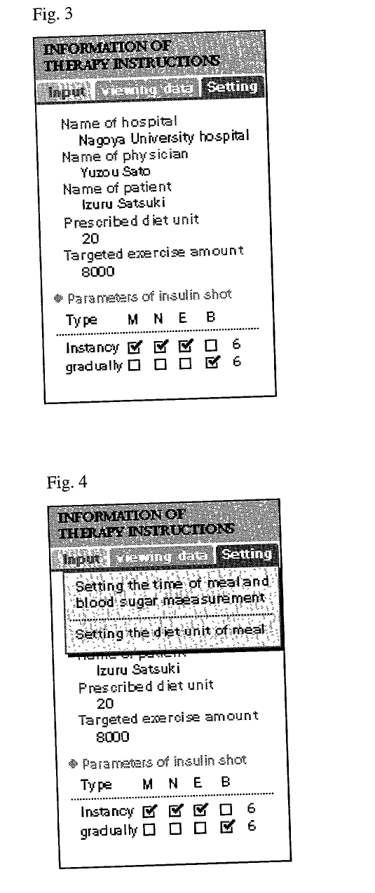

The display menu as shown in FIG. 3 will be given when the start button is pressed. It has a pull-down menu on its top through which one can feed input, view data, or implement settings.

If patient A presses the block indicated “Setting” in the pull-down menu using a pen dedicated for the purpose (to be referred to as “tap” hereinafter), a menu as shown in FIG. 4 necessary for introducing new settings will be displayed.

Let's assume, for illustration, patient A wants to set new values for the time of meal and for the time of blood sugar measurement. Then, he/she will take following steps.

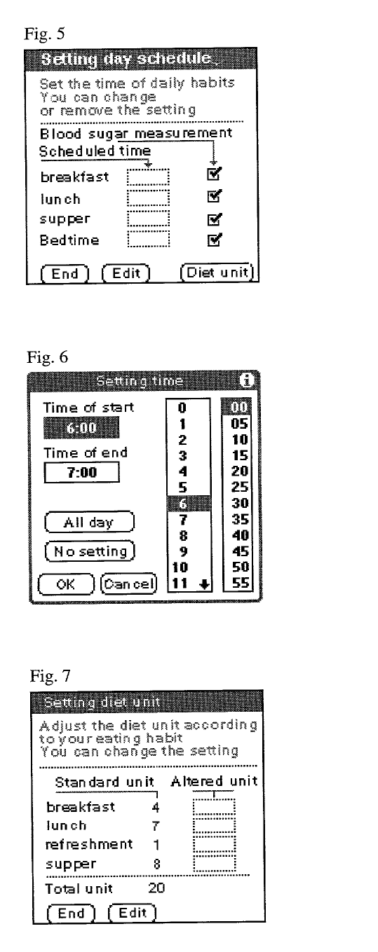

Having the pull-down menu as shown in FIG. 4 at hand, patient A will tap a block indicated “Setting the time of meal and blood sugar measurement,” and obtain a menu as shown in FIG. 5 prompting the setting of daily intake of meal and execution of blood sugar measurement.

Through this menu, patient A will set the time of meal according to his/her habit, and the time of blood sugar measurement to be inserted in a good timing with respect to each meal.

If patient A wants to set a measurement of blood sugar level after a meal, he/she will tap the box associated with the meal, and then a check mark will appear on the box. If patient A wants to erase the check mark, he/she will simply tap the box again, and then the box will return to the original open state.

If patient A wants to set the time of a meal, he/she will tap a block indicated “Scheduled time” and enclosed with dotted lines, and then have a menu as shown in FIG. 6 through which one can set the time of the meal. Patient A will feed an appropriate time through this menu, tap an [OK] button, and return to the display as shown in FIG. 5.

If patient A taps an end button on the display of FIG. 5, he/she will return to the display of FIG. 3.

The setting of the number of diet units for each meal to be taken daily occurs as follows.

If patient A taps a block indicated “Setting daily diet units of each meal,” he/she will obtain a menu as shown in FIG. 7 through which one can set the daily diet units of each meal.

This menu will give the total daily diet units prescribed by the physician, and the standard diet units of each meal, and using this menu patient A can finely adjust the prescription according to his preference and eating habit.

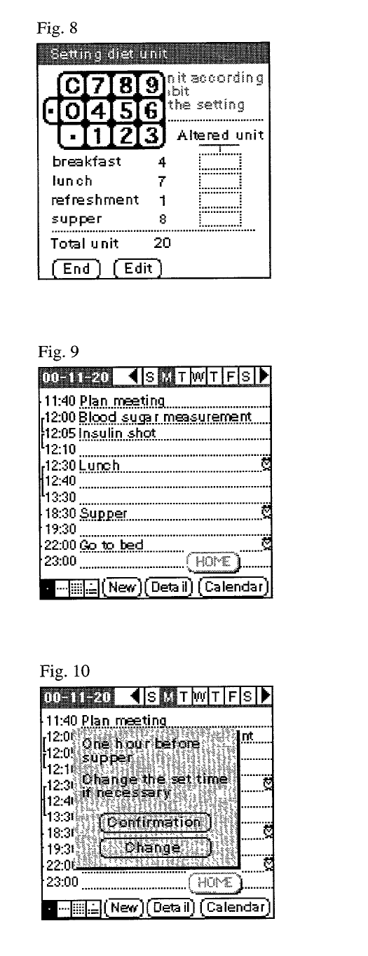

If patient A taps a box indicated “Altering diet units” and enclosed with dotted lines, he/she will obtain a “pad for numerical entry” as shown in FIG. 8. Patient A can feed a number representing a desired unit through this pad.

After necessary numbers have been fed, the portable terminal will make a calculation using the numbers to see whether the newly entered diet units are coincident with the daily total diet units prescribed by the physician, and will inform, through display, the patient of the altered food units being in short of or in excess of the prescribed units.

If patient A taps an end button on the display as shown in FIG. 8, he/she will return to the menu display as shown in FIG. 3

Take Case 1 where patient A engages in the control of diabetes following the instructions given through the therapy-oriented portable terminal.

The portable terminal automatically delivers instructions necessary for the daily control of the disease, based on the settings implemented by the physician and patient A, thereby supporting the actions to be taken by patient A for controlling the diabetes.

The daily supportive actions provided by the portable terminal will be described, with an attention restricted to the behavior of patient A over a period around a supper.

Let's further assume, for illustration, patient A set the time for the supper at six thirty in the evening.

One hour before supper (six thirty), the portable terminal will automatically give a buzzing sound, present the schedule of that day as shown in FIG. 9, and then show a display as shown in FIG. 10 through which one can alter the time of meal.

If patient finds no reason to alter the scheduled time of supper, he/she will press a “Confirmation” button, and then the terminal will be ready for an action to be taken thirty minutes before supper.

Let's assume, for illustration, patient A wants to alter the time of the supper from six thirty to seven. He/she will tap a “Change” button, to alter the time of the supper.

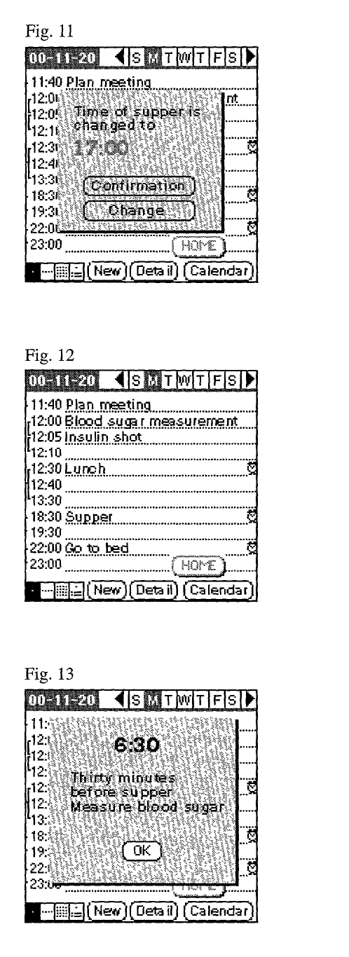

Then, a display as shown in FIG. 11 will appear through which one can alter the time of meal. Patient A will tap on necessary numbers, for example, 7 and 00 in this particular case, check whether the numbers are properly fed, and tap an [OK] button after confirmation. Then, patient A will obtain a display as shown in FIG. 12 indicating the time of supper is altered.

After confirming the alteration, patient A switches off the portable. terminal, and resumes original works.

Take Case 2 where patient A engages in the control of diabetes following the instructions given through the therapy-oriented portable terminal.

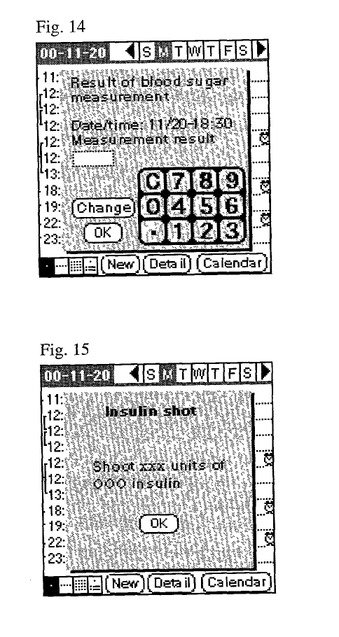

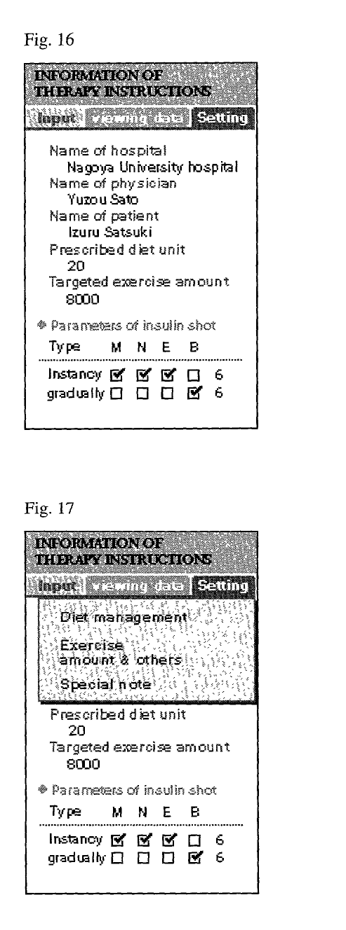

Thirty minutes before supper (seven), the portable terminal will automatically give a buzzing sound, present the schedule of that day as shown in FIG. 12, and then show a display as shown in FIG. 13 to prompt the measurement of blood sugar level. If patient A taps an [OK] button on the display of FIG. 13, he/she will have a display as shown in FIG. 14 to prompt him/her to enter a number representing the result of blood sugar measurement.

Patient A measures the blood sugar level with a blood sugar meter carried by him/her, enters a number representing the measurement result through the numerical pad, and taps an [OK] button, and then will obtain a display as shown in FIG. 15 to prompt him/her to administer insulin.

Patient A confirms the type of insulin and its dosage on display, and shoots a dose of insulin as prescribed.

After completing the shot, patient A will tap an [OK] button on the display of FIG. 15, and then he/she will have a display showing the history of that day in which the times of blood sugar measurements and of insulin shots are checked.

This is the basic actions taken by patient A with respect to a supper relying on the supportive actions from the portable terminal.

Various data necessary for the successful control of diabetes will be described below.

The description will be restricted to the entry of data necessary for the successful control of diabetes, excluding those required for the blood sugar measurement and for the insulin administration.

If one wants to feed such data, he/she will tap a block indicated “Input” on the display as shown in FIG. 3, and then have a menu as shown in FIG. 17 through which he/she can feed input.

Entry of the data regarding exercise and others will occur as a mass as follows.

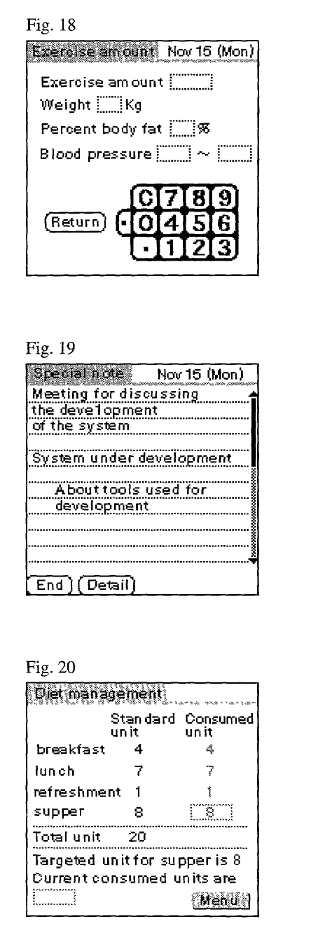

If one wants to feed data regarding the amount of exercise, weight, body fat, blood pressure, etc., he/she will tap a block indicated “Exercise and others” in the menu as shown in FIG. 17, and then will have a display as shown in FIG. 18 through which he/she can feed necessary input.

If one wants to take a note of rules to be observed in everyday life, he/she will operate on the terminal as follows.

If a patient wants to take a note of a rule to be observed for the successful control of diabetes, he/she will tap a block indicated “Special note” on a menu as shown in FIG. 17 and then will have a display as shown in FIG. 19 through which he/she can feed necessary input.

If a patient wants to manage his/her diet, he/she will operated on the terminal as follows.

For management of the daily diet, the patient will tap a block indicated “Diet management” on the display of FIG. 17, and then will have a display as shown in FIG. 20 through which he/she can feed input necessary for the management of diet.

The screen of FIG. 20 gives a display where four, seven and one units are prescribed for breakfast, lunch and refreshment respectively while eight units are prescribed for supper. This means the supper will accord with the prescription, as long as the units contained in the supper are equal to or less than eight units.

Selection of appropriate dishes will occur as follows.

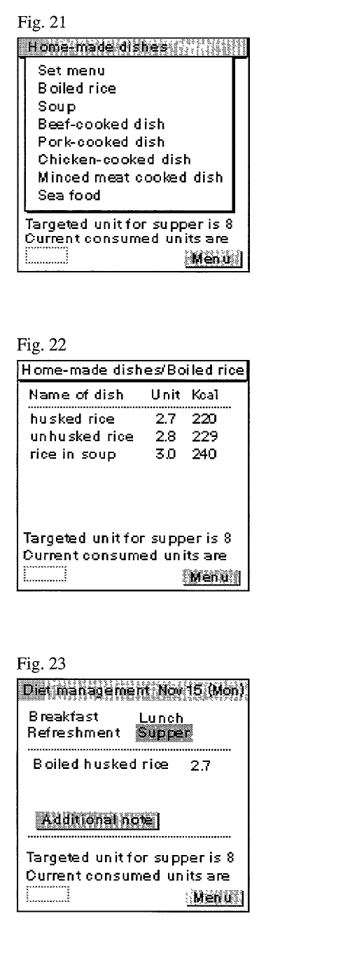

If a patient taps a [Menu] button downward on the right on a display as shown in FIG. 20, he/she will have a display as shown in FIG. 21 to give a meal menu.

The menu of FIG. 21 relates mainly to home-made dishes, but the patient, as desired, can have a display to give a menu of dishes served by nearby restaurants or by caterers.

Let's assume, for illustration, patient A selects a menu of homemade dishes.

Firstly, if patient A taps a block indicated “Boiled rice” from the menu of home-made dishes, he/she will receive another menu of variously cooked rice.

If patient A taps a block indicated “Boiled husked rice,” he/she will have a display as shown in FIG. 23 to present the “Unit data for cumulative calculation.”

This display to indicate the “Unit data for cumulative calculation” will give data such as the date of recording including the day, month and year, and the relevant meal including breakfast, lunch, refreshment and supper, as well as the boiled husked rice selected above together with its units: in this particular case 2.7 units are given which indicate the fraction of the boiled husked rice in the eight units assigned to the supper.

Then, the patient will select supplementary dishes. If he/she taps a button indicated “Additional writing” on the display of FIG. 23, he/she will return to the display of FIG. 21 to present home-made dishes.

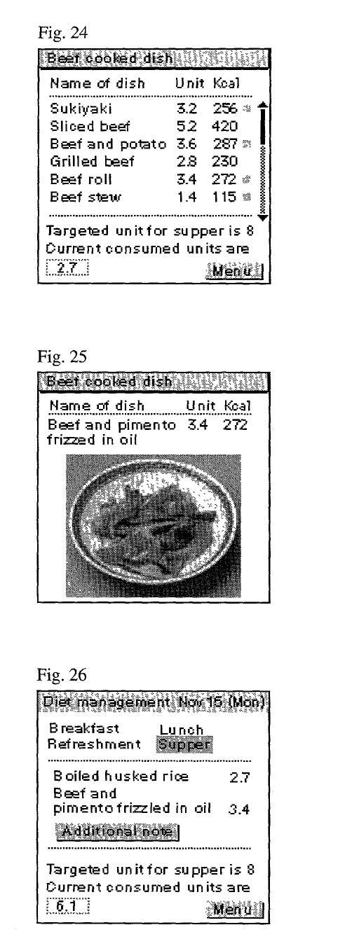

If the patient taps a block indicated “Beef-based dishes,” he/she will have a menu of beef-based dishes as shown in FIG. 24.

In FIG. 24, the solid square placed on the right end of each dish is a button which, if pressed, will give a photograph of the dish to help the patient visually identify the dish. Thus, if the patient taps a solid square, a display as shown in FIG. 25 will be given.

If the patient taps a block indicated “Beef and pimento frizzled in oil,” he/she will have a display as shown in FIG. 26, or the same display as in FIG. 23 except that a dish consisting of beef and pimento frizzed in oil is newly added.

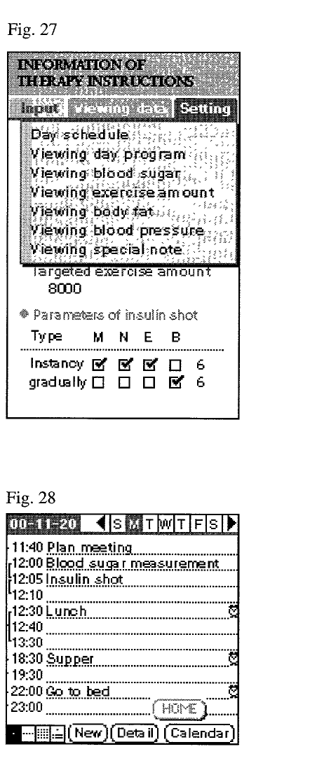

A display as shown in FIG. 27 gives a menu of the supper which consists of vegetable root salad as well as of the aforementioned dishes, the units of which meet the units prescribed for the supper. The data will be registered to a database stored in the portable terminal.

Moreover, the patient can review various data fed during the control of the diabetes.

If the patient wants to review certain data stored in a database of the portable terminal, he/she will start from a pull-down menu for viewing data (see FIG. 27) pulled from the top of the menu display of FIG. 3.

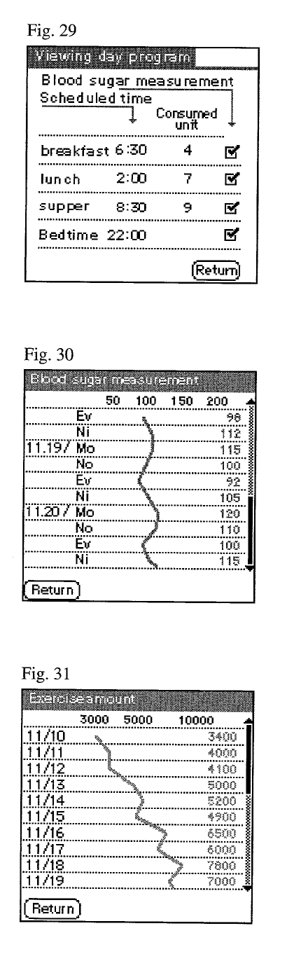

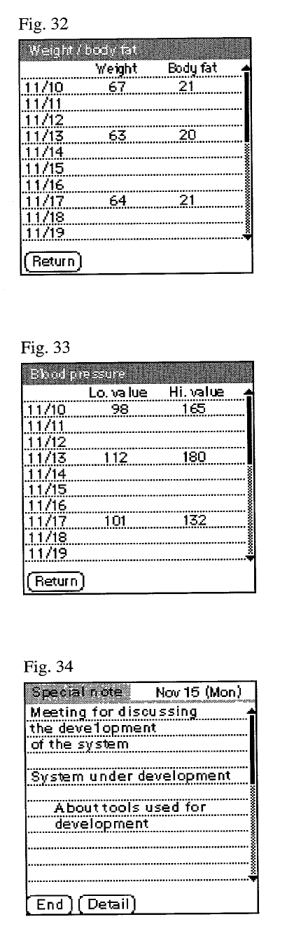

Through this menu, the patient can gain access to displays for viewing a daily schedule (FIG. 28), daily program (FIG. 29), the change of blood sugar level (FIG. 30), the change of exercise amount (FIG. 31), the change of body weight and fat (FIG. 32), the change of blood pressure (FIG. 33) and special notes (FIG. 34).

So much for the description of the basic operation of the portable terminal carried by patient A.

The term “information of therapy instructions” used herein refers to every instruction and teaching given by the physician for the treatment of a given disease; and the term “information of patient's result report” used herein refers to every therapy result obtained from a patient to which the therapy is applied such as the actions taken by the patient in compliance with the instructions from the physician, and the results of therapy applied to the patient in compliance with the instructions from the physician including the results of daily blood sugar measurement, data of various tests, the number of insulin administration, the dosage of insulin, the diet units of each meal, the exercise amount (in terms of steps measured with a pedometer), the amount of consumed calorie, etc.

The term may also include the data of blood pressure and weight of the patient obtained as appropriate.

Patient A revisits the hospital carrying the portable terminal or portable telephone unit, and hands it to the physician. The portable terminal or portable telephone unit is electrically connected to the host computer; and the information of therapy results fed by patient A during the period between the previous visit and this visit is transmitted to the host computer. The physician views the data, examines patient A, gives him/her new instructions, and updates the information of therapy and instructions. Those renewed data are transmitted to the portable terminal or portable telephone unit.

In the above description, attention has been mainly restricted to the treatment of a diabetic patient, but of course this invention can be applied to the treatment of other diseases such as hypertension, heart diseases, renal diseases, gout, and diseases resulting from everyday habits, using appropriate parameters suitable for the disease, as long as the application falls within the scope of this invention as defined by the appended claims.

According to this invention, it is also possible for a portable terminal to connect a patient through a network with a catering service provider, and to allow the caterer to provide the patient with a diet matching his/her disease.

Because the portable terminal is provided with various high-grade functions such as storage of data, display, generation of an alarming sound, etc., it allows the physician and the patient to give a more detailed and precise description of prescription and instructions, and of therapy results than would be possible if the same were done by mouth or by a document. Accordingly, it will be possible for the patient to accurately grasp the instructions from the physician, which may lead to the more faithful observance by the patient of the instructions from the physician.

In the above description, attention has been mainly restricted to the treatment of a diabetic patient based on the use of a therapy-oriented portable terminal. The portable terminal may incorporate a package including a palm device and a palm OS containing device combined as a diabetes care menu. Then, the patient will manage his/her disease by him/herself, utilizing the functions of the portable terminal such as memory, calculation, display, alarm, calendar, address, communication through a network, etc.

If the patient wants to feed data necessary for the management of disease, it will be of course possible for him/her to obtain measurement results such as blood sugar levels by using an appropriate meter, and to feed them by him/herself. However, it is also possible to electrically connect the meter with the portable terminal, thereby allowing the meter to directly transmit measurement results to the device in the terminal through a cable or using an infra-red beam.

According to this invention, it is possible for a diabetic patient to timely and regularly measure blood sugar levels and give insulin shots which must be usually done several times a day, no matter how much he/she may be absorbed in his/her doings, because the terminal alarms the patient at a good timing in correspondence with his/her prescription.

According to this invention, the diabetic patient can avoid the necessity of complicated calculations required for the acquisition of the calorie of a meal, as well as the consumed amount.

According to this invention, it is possible for the physician to accurately grasp the condition of a patient, based on the data accumulated in a host computer, as well as on the data fed by the patient while he/she was at home, and thus to apply a right therapy, and give a proper advice to the patient, and to use those data as a material for a renewed examination.

Conventionally it is a custom for a diabetic patient to carry a note with him/her to record the measurement results of blood sugar level, and the data of insulin shots by hand several times for a day. This is so cumbersome that the patient often neglects to record. According to the system of this invention, the terminal or the telephone unit is so handy that it can be freely carried while being kept in a breast pocket, and it only requires simple manipulation even when the entry or storage of data is required, because it incorporates an excellent dedicated program.

Because this invention has a configuration as described above, it will allow the exchange of information between a physician and a patient, or transmission of the information of the prescription and instructions from the physician to the patient to occur at a higher level than is possible with conventional means. This arrangement will make it possible for the physician to accurately grasp the condition of the patient, and for the patient to rightly understand the prescription and instructions given to him/her by the physician, which will help the patient precisely and easily follow the prescription and instructions.

While the invention has been particularly shown and described with reference to preferred embodiments thereof, It will be understood by those skilled in the art that the foregoing and other changes in form and details can be made therein without departing from the spirit and scope of the invention.

What is claimed is:

1. A therapy management system having a host computer on the side of a physician and a computer on the side of a patient wherein the physician side host computer comprises at least:
a display means to display the information of therapy instructions including the name of the patient, the treatment data of the patient, and the instructions from the physician;
a recording means to record the name of the patient, the treatment data of the patient, and the instructions from the physician;
a memory means to store the name of the patient, the treatment data of the patient, and the instructions from the physician;
a transmission means to transmit the information of therapy instructions to the patient side computer;
a receiving means to receive the information of patient's report result transmitted by the patient side computer;
a display means to display the information of patient's report result;
a memory means to store the information of patient's report result;
a memory means to store the information of the patient's past medical history;
a memory means to store the information of patient's past report result;
a memory means to store the information of updated therapy instructions; and
a transmission means to transmit the information of updated therapy instructions to the patient side computer, while the patient side computer comprises at least:
a receiving means to receive the information of therapy instructions including the name of the patient, the treatment data of the patient, and the instructions from the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a recording means to record the treatment data obtained by measurement;
a display means to display the treatment data obtained by measurement;
a memory means to store the treatment data obtained by measurement; and
a transmission means to transmit the stored information of the patient's report result to the host computer on the side of the physician.

2. A therapy management system as described in claim 1 wherein the patient side computer comprises a portable terminal.

3. A therapy management system as described in claim 1 wherein the patient side computer comprises a portable telephone unit.

4. A therapy management system as described in claim 1 wherein the physician side host computer comprises at least:
a display means to display the information of therapy instructions including the name of the patient, the treatment data of the patient, and the instructions from the physician;
a recording means to record the information of therapy instructions including the name of the patient, the treatment data of the patient, and the instructions from the physician;
a memory means to store the information of therapy instructions including the name of the patient, the treatment data of the patient, and the instructions from the physician;
a transmission means to transmit the information of therapy instructions to the patient side computer;
a receiving means to receive the information of patient's report result transmitted from the patient side;
a display means to display the information of patient's report result;
a memory means to store the information of patient's report result;
a memory means to store the information of the patient's past medical history;
a memory means to store the information of patient's past report result;
a memory means to store the information of updated therapy instructions; and
a transmission means to transmit the information of updated therapy instructions to the patient side computer,
while the patient side computer comprises at least:
a receiving means to receive the information of therapy instructions including the name of the patient, the treatment data of the patient, and the instructions from the physician transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level thus recorded;
a display means to display an exercise amount;
a recording means to record an amount of exercise actually performed;
a memory means to store the record; and
a transmission means to transmit the stored information of the patient's report result to the host computer on the side of the physician.

5. A therapy management system as described in claim 2 wherein the portable terminal on the side of the patient comprises at least:
a receiving means to receive the information of therapy instructions including the name of the patient, the treatment data of the patient, and the instructions from the physician, transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level thus recorded;
a display means to display an exercise amount;
a recording means to record an amount of exercise actually performed;
a memory means to store the record; and
a transmission means to transmit the stored information of the patient's report result to the host computer on the side of the physician.

6. A therapy management system as described in claim 2 wherein the portable terminal on the side of the patient comprises at least:
a receiving means to receive the information of therapy instructions including the name of the patient, the treatment data of the patient, and the instructions from the physician, transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level thus recorded;
a display means to display the time for dispensing a medicine;
a memory means to store a time for dispensing a medicine;
a notifying means to notify the time for dispensing a medicine;
a recording means to record the result of the dispensation of a medicine;
a display means to display the result of the dispensation of a medicine;
a memory means to store the result of the dispensation of a medicine;
a display means to display a time of insulin injection;
a memory means to store the time for insulin injection;
a notifying means to notify the time for insulin injection;
a recording means to record the result of insulin injection;
a display means to display the result of insulin injection;
a memory means to store the result of insulin injection;
a display means to display an exercise amount;
a recording means to record an amount of exercise actually performed;
a memory means to store the record; and
a transmission means to transmit the stored information of the patient's report result to the host computer on the side of the physician.

7. A patient side computer used for the therapy management system as described in claim 1 to be applied to a diabetic patient, comprising at least:
a receiving means to receive the information of therapy instructions including the name of the patient, the treatment data of the patient, and the instructions from the physician, transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level-thus recorded;
a display means to display a time for dispensing a medicine;
a memory means to store the time for dispensing a medicine;
a notifying means to notify the time for dispensing a medicine;
a recording means to record the result of the dispensation of a medicine;
a display means to display the result of the dispensation of a medicine;
a memory means to store the result of the dispensation of a medicine;
a display means to display a time of insulin injection;
a memory means to store the time for insulin injection;
a notifying means to notify the time for insulin injection;
a recording means to record the result of insulin injection;
a display means to display the result of insulin injection;
a memory means to store the result of insulin injection;
a display means to display an exercise amount;
a recording means to record an amount of exercise actually performed;
a memory means to store the record; and
a transmission means to transmit the stored information of the patient's report result to the host computer on the side of the physician.

8. A portable terminal for a diabetic patient comprising at least:
a receiving means to receive the information of therapy instructions including the name of the patient, the treatment data of the patient, and the instructions from the physician, transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level thus recorded;
a display means to display a time for dispensing a medicine;
a memory means to store the time for dispensing a medicine;
a notifying means to notify the time for dispensing a medicine;
a recording means to record the result of the dispensation of a medicine;
a display means to display the result of the dispensation of a medicine;
a memory means to store the result of the dispensation of a medicine;
a display means to display a time for insulin injection;
a memory means to store the time for insulin injection;
a notifying means to notify the time for insulin injection;
a recording means to record the result of insulin injection;
a display means to display the result of insulin injection;
a memory means to store the result of insulin injection;
a display means to display an exercise amount;
a recording means to record an amount of exercise actually performed;
a memory means to store the record; and
a transmission means to transmit the stored information of the patient's report result to the host computer on the side of the physician.

9. A portable telephone unit for a diabetic patient comprising at least:
a receiving means to receive the information of therapy instructions including the name of the patient, the treatment data of the patient, and the instructions from the physician, transmitted from the host computer on the side of the physician;
a memory means to store the thus received information of therapy instructions including the name of the patient, the treatment data of the patient, and the instructions from the physician;
a display means to display the thus received information of therapy instructions including the name of the patient, the treatment data of the patient, and the instructions from the physician;
a display means to display the actions to be taken by the patient in compliance with the instructions from the physician;
a notifying means to notify the patient of the actions to be taken in compliance with the instructions from the physician;
a recording means to record the actions actually taken by the patient in compliance with the instructions from the physician;
a memory means to store the recorded content;
a display means to display the time of meal;
a setting means through which one can set the time of meal;
a memory means to store the time of meal thus set;
a notifying means to notify the time of meal thus set;
an altering means through which one can alter the set time of meal;
a display means to display the time of meal thus altered;
a memory means to store the time of meal thus altered;
a display means to display the diet unit of a meal;
a setting means through which one can set the diet unit of a meal;
a memory means to store the diet unit of a meal thus set;
a display means to display a time for blood sugar measurement;
a memory means to store the time for blood sugar measurement;
a notifying means to notify the time for blood sugar measurement;
a recording means to record a blood sugar level obtained by measurement;
a display means to display the blood sugar level thus recorded;
a memory means to store the blood sugar level thus recorded;
a display means to display a time for dispensing a medicine;
a memory means to store the time for dispensing a medicine;
a notifying means to notify the time for dispensing a medicine;
a recording means to record the result of the dispensation of a medicine;
a display means to display the result of the dispensation of a medicine;
a memory means to store the result of the dispensation of a medicine;
a display means to display a time for insulin injection;
a memory means to store the time for insulin injection;
a notifying means to notify the time for insulin injection;
a recording means to record the result of insulin injection;
a display means to display the result of insulin injection;
a memory means to store the result of insulin injection;
a display means to display an exercise amount;
a recording means to record an amount of exercise actually performed;
a memory means to store the record; and
a transmission means to transmit the stored information of the patient's report result to the host computer on the side of the physician.
